(19) United States
(12) Patent Application Publication
(10) Pub. No.: US 2017/0322970 A1
(43) Pub. Date: Nov. 9, 2017

(54) DATA ORGANIZING AND DISPLAY FOR DYNAMIC COLLABORATION

(71) Applicant: International Business Machines Corporation, Armonk, NY (US)

(72) Inventors: Matthew R. Alexander, Raleigh, NC (US); Lisa M. Frankel, Acton, MA (US); Masabumi Koinuma, Lexington, MA (US); Yuhong Yin, Westford, MA (US)

(21) Appl. No.: 15/145,462

(22) Filed: May 3, 2016

(51) Int. Cl. G06F 17/30; G06F 3/0488; G06F 3/0485; G06F 17/21; G06F 3/0482

(52) U.S. Cl. CPC G06F 17/30424; G06F 17/212; G06F 3/0482; G06F 3/0485; G06F 3/04883

(57) ABSTRACT

A computer identifies editable text fields within a file and extracts the contents, if any, from the identified editable text fields. The computer identifies one or more tags associated with the extracted content and stores the extracted content in association with the identified tag. The computer then determines, when displaying the editable text fields on a device, whether to replace the extracted content with one or more selectable tiles corresponding to the tags associated with the extracted content. Based on determining to replace the extracted content with tiles corresponding to the tags associated with the extracted content, the computer displays selectable tiles corresponding to the tags associated with the extracted content instead of displaying the content itself. Responsive to receiving user input from a user selecting a tile, the computer displays the content associated with the tag corresponding to the selected tile.

BACKGROUND

The present invention relates generally to organizing data, and more particularly to organizing and displaying data using tags. Editable text fields are a common tool for receiving user input data in applications, websites, and other software programs today. Such editable text fields allow users to input data which may then be displayed to others, such as a comments or feedback. As increased amounts of data are input within editable text fields, however, information becomes increasingly more difficult to locate and utilize. For example, a user may have to scroll through dozens of comments before finding a comment of particular relevance. Furthermore, existing schemas for displaying said information may be incapable of handling and presenting the increased amounts of data to a user, particularly in the case of mobile applications where screen size is limited. While schemas can be redefined to accommodate the increased amount of information, it is often a costly process in both time and money. In addition, redefining a schema may not address the problem of efficiently presenting relevant information to a user when large amounts of data, such as comments, are displayed.

### SUMMARY

Embodiments of the present invention disclose a method, system, and computer program product for a data organizing and display system. A computer identifies editable text fields within a file and extracts the contents, if any, from the identified editable text fields. The computer identifies one or more tags associated with the extracted content and stores the extracted content in association with the identified tag. The computer then determines, when displaying the editable text fields on a device, whether to replace the extracted content with one or more selectable tiles corresponding to the tags associated with the extracted content. Based on determining to replace the extracted content with tiles corresponding to the tags associated with the extracted content, the computer displays selectable tiles corresponding to the tags associated with the extracted content instead of displaying the content itself. Responsive to receiving user input from a user selecting a tile, the computer displays the content associated with the tag corresponding to the selected tile.

### BRIEF DESCRIPTION OF THE SEVERAL VIEWS OF THE DRAWING

FIG. 1 illustrates a data organizing system, in accordance with an embodiment of the present invention.

FIG. 2 is a flowchart illustrating the operation of the organizing program of FIG. 1 in organizing data based on associated tags, in accordance with an embodiment of the present invention.

FIG. 3 is a graphical depiction of the software client of FIG. 1 prior to organization of data by the organizing program of FIG. 1, in accordance with an embodiment of the present invention.

FIG. 4 is a graphical depiction of the software client of FIG. 1 following organization of data by the organizing program of FIG. 1, in accordance with an embodiment of the present invention.

FIG. 5 is a graphical depiction of the software client of FIG. 1 following a user selection of a tile associated with a tag, in accordance with an embodiment of the present invention.

FIG. 6 is a graphical depiction of the software client of FIG. 1 throughout a user press, hold, and release of a tile associated with a tag, in accordance with an embodiment of the present invention.

FIG. 7 is a graphical depiction of the software client of FIG. 1 following a user selection of a tile associated with a tag, in accordance with an embodiment of the present invention.

FIG. 8 is a block diagram depicting the hardware components of the data organizing system of FIG. 1, in accordance with an embodiment of the invention.

### DETAILED DESCRIPTION

Embodiments of the present invention will now be described in detail with reference to the accompanying figures.

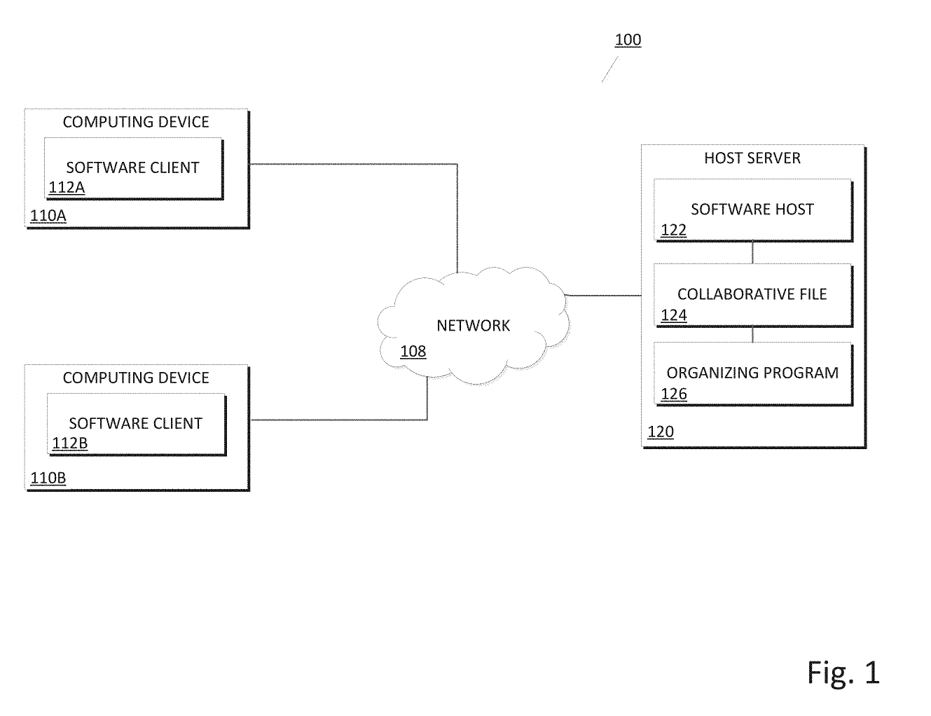

FIG. 1 illustrates a data organizing system 100, in accordance with an embodiment of the invention. In the example embodiment, data organizing system 100 includes computing device 110A, computing device 110B, and host server 120, all interconnected via network 108.

In the example embodiment, network 108 may be the Internet, representing a worldwide collection of networks and gateways to support communications between devices connected to the Internet. Network 108 may include, for example, wired, wireless, or fiber optic connections. In other embodiments, network 108 may be implemented as an intranet, a local area network (LAN), or a wide area network (WAN). In general, network 108 can be any combination of connections and protocols that will support communications between computing device 110A, computing device 110B, and host server 120.

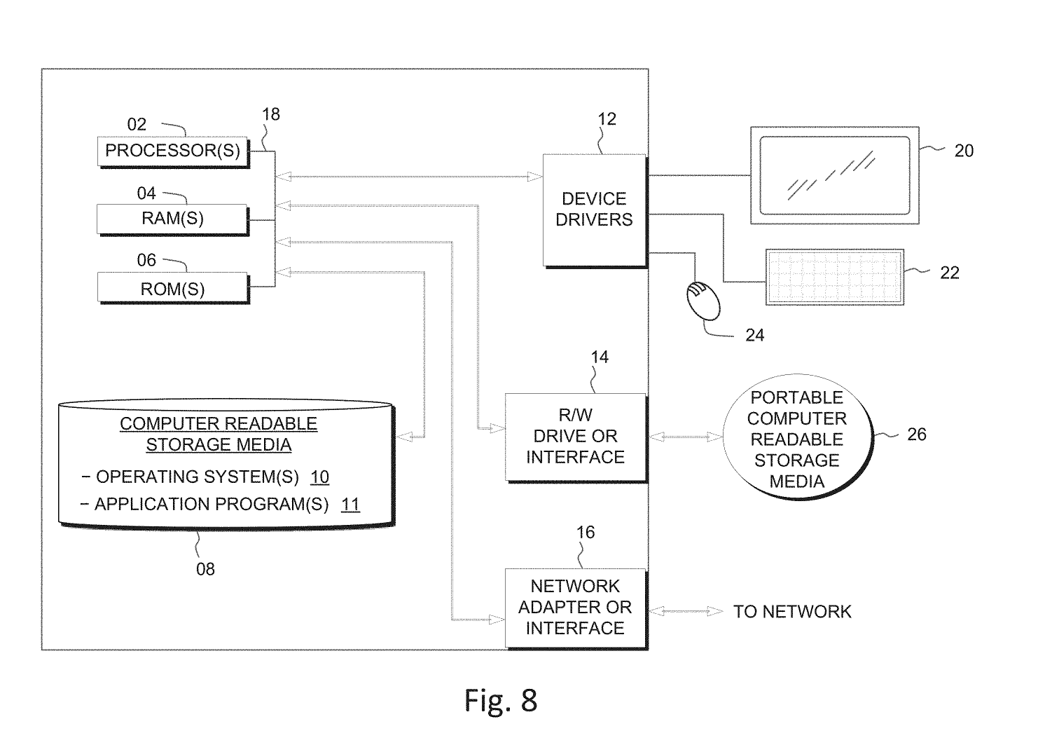

In the example embodiment, computing device 110A includes software client 112A and computing device 110B includes software client 112B. In the example embodiment, each of computing devices 110 (i.e. computing device 110A and computing device 110B) may be laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. While each of computing devices 110 are shown as a single device, in other embodiments, computing devices 110 may be comprised of a cluster or plurality of computing devices, working together or working separately. Computing devices 110 are described in more detail with reference to FIG. 8.

In the example embodiment, software client 112A and software client 112B are client programs on computing device 110A and computing device 110B, respectively, which maintain client-server relationships with a host server program, such as software host 122 on host server 120. In the example embodiment, software clients 112 (i.e. software client 112A and software client 112B) are computer programs which act as a user interface for one or more users, such as the users of computing devices 110, to communicate with host program 122. In the example embodiment, software clients 112 are capable of instructing host program 122 to read, write, or otherwise edit a collaborative work maintained on host server 120, such as collaborative file 124. For example, software clients 112 may be web browsers which provide a web client interface to read, write, or otherwise edit a collaborative ticket (collaborative file 124) via software host 122 on server 120. In the example embodiment, collaborative file 124 is stored on a host server, such as host server 120, and modifications to the collaborative work are made in real time. In other embodiments, however, modified copies of collaborative file 124 may be temporarily stored on each of computing devices 110 and replicated to a master copy of collaborative file 124 on host server 120 via data replication techniques. While in the example embodiment a user interacts with software host 122 and collaborative file 124 via software clients 112, in other embodiments, a user may interact directly with software host 122 to edit collaborative file 124.

In the example embodiment, host server 120 includes software host 122, collaborative file 124, and organizing program 126. In the example embodiment, host server 120 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. While host server 120 is shown as a single device, in other embodiments, host server 120 may be comprised of a cluster or plurality of computing devices, working together or working separately. Host server 120 is described in more detail with reference to FIG. 8.

In the example embodiment, software host 122 is a server program on host server 120 which maintains a client-server relationship with one or more client programs, such as software clients 112 on computing devices 110. In the example embodiment, software host 122 is computer program which is capable of receiving instructions from one or more users of software clients 112 on computing devices 110. In the example embodiment, the received instructions read, write, or otherwise modify a collaborative work, such as collaborative file 124 on host server 120, in real time. For example, if collaborative file 124 is a webpage, then software host 122 receives and applies modifications to the hypertext markup language associated with collaborative file 124 from software clients 112 acting as web browsers. In other embodiments, software host 122 may be stored on other devices, such as computing devices 110. Furthermore, in other embodiments, a user may interact directly with software host 122 (rather than indirectly via software clients 112) to edit collaborative file 124.

Collaborative file 124 is a document stored on host server 120 which is integrated with software host 122 and organizing program 126. In the example embodiment, collaborative file 124 is a document which is edited by software host 122 in accordance with instructions transmitted from one or more users on software clients 112. While in the example embodiment, collaborative file 124 is stored on host server 120, in other embodiments, collaborative file 124 may be stored on other computing devices, such as computing devices 110. Furthermore, other embodiments may implement alternative data replication techniques known in the art to modify collaborative file 124.

In the example embodiment, organizing program 126 is a computer program on host server 120 which is integrated with collaborative file 124 and software host 122. In the example embodiment, organizing program 126 is capable of detecting editable text fields within a collaborative work, such as collaborative work 124. In addition, organizing program 126 is capable of extracting content from identified text fields and storing the content in association with an identified tag. Furthermore, organizing program 126 is additionally capable of determining whether to display the tags to a user in lieu of the extracted content associated with the tags. Based on determining to display the tags in lieu of the extracted content, organizing program 124 is further capable of receiving a user input selecting one or more tags and displaying the extracted content corresponding to the selected one or more tags.

While in the example embodiment software host 122, collaborative file 124, and organizing program 126 are stored on host server 120, in other embodiments, software host 122, collaborative file 124, and organizing program 126 may be stored and work cooperatively on other devices, such as computing devices 110. Furthermore, other embodiments may eliminate the need for software clients 122 such that a user may interact directly with software host 122.

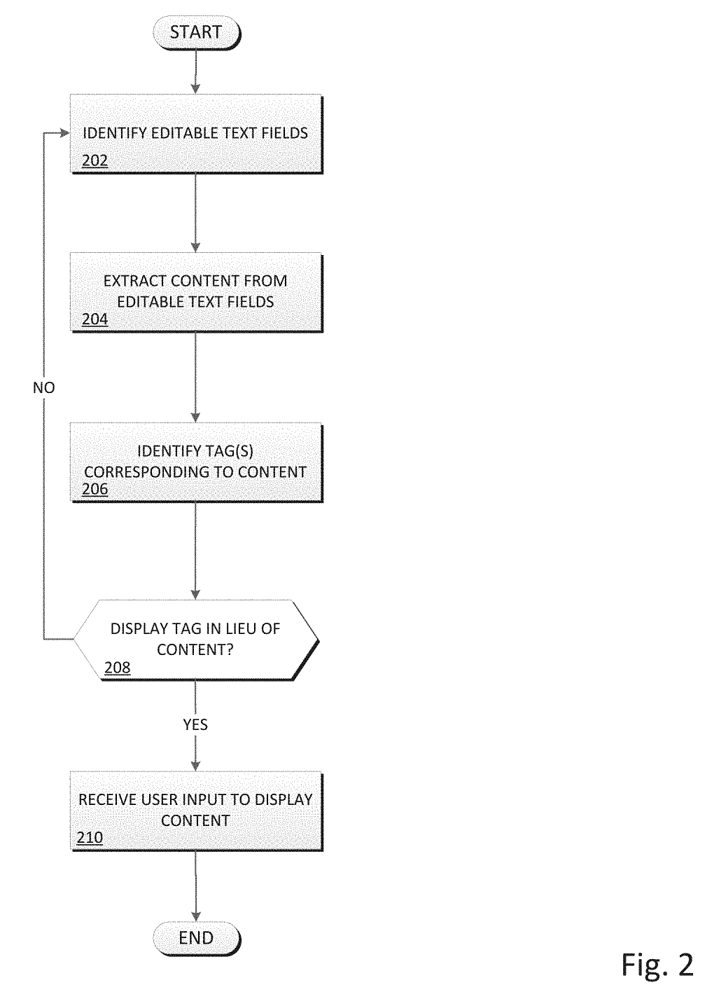

FIG. 2 is a flowchart depicting the operation of organizing program 126 in organizing and displaying the content of editable text fields based on associated tags. Editable text fields, such as user comment fields, are commonly used in websites and applications. Increasing ease and accessibility of editable text fields to users, for example the availability of mobile devices and remote internet access, has resulted in increased amounts of data entered into said editable text fields. However, existing system schemas and metadata configurations may not be configured to handle and/or display the increased amount of received data, particularly on mobile devices. Furthermore, increased amounts of unstructured data make identifying/locating relevant data increasingly difficult for a user. Rather than redefining the existing schema to accommodate the additional data or displaying device, this invention aims to rapidly sort and display data using tags without the costly process of redefining the existing schema.

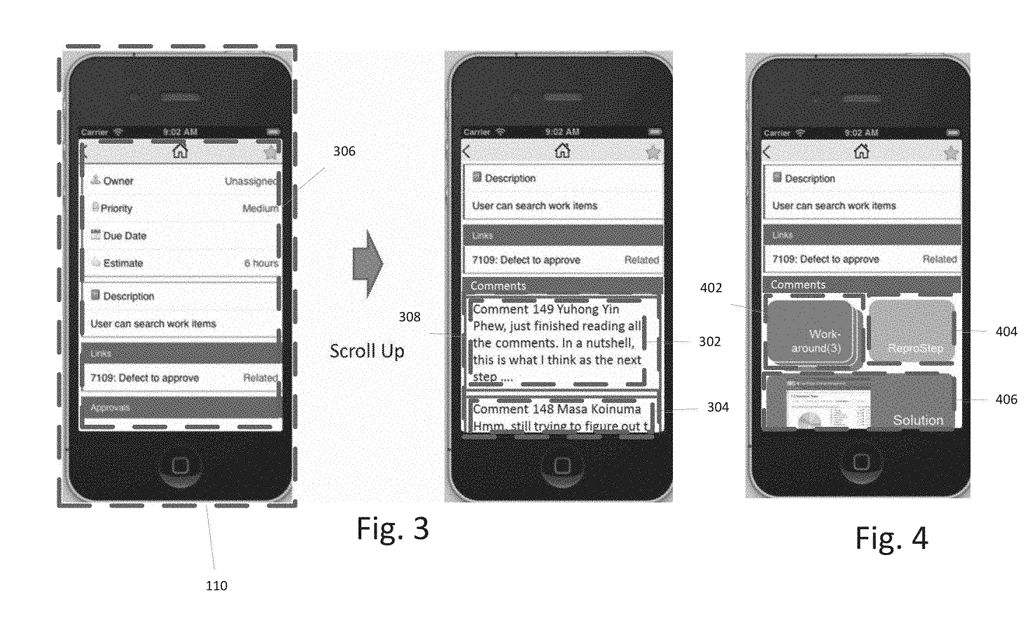

Organizing program 126 identifies editable text fields within collaborative file 124 (step 202). In the example embodiment, organizing program 126 identifies editable text fields within collaborative file 124 by communicating with software host 122. In the example embodiment, software host 122 is capable of reading, writing, and otherwise modifying the program code of collaborative file 124. Based on analyzing the syntax and structure of the programming language and/or markup language defining collaborative file 124, software host 122 is capable of determining which elements or nodes of collaborative file 124 are capable of receiving a user input. For example, if collaborative file 124 is a webpage, then organizing program 126 searches the Hypertext Markup Language (HTML) code associated with collaborative file 124 for specific, user configured elements indicative of an editable text field, such as containers. Now referring to an example in FIG. 3 illustrating collaborative file 124 as a collaborative ticket and software clients 112 as web browsers, if organizing program 126 searches the HTML corresponding to collaborative file 124 for editable text fields, then organizing program 126 identifies editable text fields 302 and 304 within Comments section 308 of collaborative file 124 (note comments section 308 encompasses both text fields 302 and 304).

Referring now back to the flowchart illustrated by FIG. 2, organizing program 126 extracts a value/content associated with the identified editable text fields 302 and 304 (step 204). Similar to determining the presence of editable text fields in step 202, organizing program 126 determines whether the identified text fields have associated content by analyzing the program code or markup language of collaborative file 124 for a “value” corresponding to the identified editable text fields. If the text field has associated content (a value), organizing program 126 extracts the contents of the text field and stores them in an annotation database. Continuing the example illustrated by FIG. 3, if organizing program 126 determines that the identified text fields of collaborative file 124 include text field 302 (Comments 149) and text field 304 (Comment 148), then organizing program 126 extracts and saves “Comment 149: Phew, just finished reading all the comments. In a nutshell, this is what I think as the next step . . . ” by Yuhong Yin and “Comment 148: Hmm, still trying to figure out t . . . ” by Masa Koinuma in an annotation database. If an identified text field does not have any associated content, then organizing program 126 monitors software host 122 for receipt of a user input value corresponding to the field. Similarly, organizing program 126 may be configured to periodically reference identified text fields for subsequent modifications to the content within each text field. If organizing program 126 determines that the content associated with a text field has been modified from the last extracted version, organizing program 126 extracts the most recent content and overwrites the previously extracted content. In other embodiments, organizing program 126 may store previously extracted content in association with a timestamp rather than being overwritten by organizing program 126. In further embodiments, organizing program 126 may be configured to identify trends and popular tags based on the timestamps associated with the tags.

Organizing program 126 identifies one or more tags corresponding to the identified content (step 206). In the example embodiment, tags are words which describe the content of a text field and are identified by organizing program 126 or received via user input from software clients 112 on computing devices 110. In embodiments where tags are received via user input, tags are entered into one of software clients 112 and transmitted to software host 122 via network 108. Organizing program 126 then identifies the tag via integration with software host 122 and compares the identified tag to a tag database of existing tags to determine whether the identified tag exists. Continuing the example illustrated by FIG. 3, if the user of software client 112A on computing device 110A, Yuhong Yin, tags text field 302 (Comment 149) as “@Fix,” then organizing program 126 compares the tag “@Fix” to a tag database to determine if the tag “@Fix” already exists. If the identified tag already exists in the tag database, the extracted content is saved in association with the existing tag. Therefore, in the example embodiment, the content of multiple text fields may be associated with a single tag. Similarly, the content of a single text field may be associated with multiple tags. While, in the example embodiment, associations are only made between the content of a text field and a corresponding tag, in other embodiments, organizing program 126 may associate content with other content having like tags through various techniques such as keyword/string matching and natural language processing.

If the identified tag does not exist in the tag database, organizing program 126 determines whether a synonymous or related tag exists in the database (step 206 cont'd). Organizing program 126 determines whether a synonymous or related tag exists by referencing a synonym or relational tag database and determining whether the identified tag is associated with any listed synonyms or related words. In the example embodiment, synonym databases detail synonyms to common terms while a relational database establishes relationships between related terms. If the identified tag is synonymous/related to an existing tag, organizing program 126 stores the extracted content in association with the existing tag. Continuing the example illustrated by FIG. 3, if the tag “@Fix” does not exist in the tag database but the synonymous “@Solution” does, then organizing program 126 associates text field 302 (Comment 149) with the tag “@Solution” rather than the identified tag, “@Fix.” In other embodiments, organizing program 126 may prompt a user selection dictating whether to associate the extracted content with the existing, synonymous tag or to save the content in association with a newly created tag corresponding to the identified tag. Continuing the example above in such an embodiment, if organizing program 126 determines that “@Fix” and “@Solution” are synonymous but only “@Solution” is an existing tag, then organizing program 124 prompts a user selection to associate Comment 149 with the existing tag “@Solution” or with a newly created tag “@Fix.” If organizing program 124 determines that no words within the content are matching/synonymous with an existing tag in the tag database, the identified tag is added to the tag database in association with the content extracted in step 204. Continuing the example illustrated by FIG. 3, if neither the tag “@Fix” nor any synonyms of the word “fix” exist in the tag database, “@Fix” is added to the tag database and the content of Comment 149 is saved in association with the tag “@Fix.” In the example embodiment, tags are stored within the tag database and are prefixed with a designated character such as a “@” or a “#.” In the example embodiment, any number of tags may be associated with the extracted content.

If organizing program 126 does not receive a tag via user input, organizing program 126 attempts to identify a tag associated with the content (step 206 cont'd). In the example embodiment, organizing program 126 identifies an associated tag by comparing existing tags (and synonymous words) within the tag database to the words within the extracted content. In the example embodiment, organizing program 126 identifies words within the extracted content using optical character recognition, natural language processing, and word/string matching techniques. In other embodiments, however, organizing program 126 may identify the words within the content in other ways. If organizing program 126 determines that one or more words within the extracted content is matching/synonymous to one or more existing tags, organizing program 126 associates the matching/synonymous tag with the content. In other embodiments, however, organizing program 126 may only associate the content with one or more of the matching, existing tags upon user confirmation via user input.

Continuing the example illustrated by FIG. 3, if Masa Koinuma, utilizing software client 112B on computing device 110B, has not associated a tag with text field 304 (Comment 148) and the tag database includes an existing tag “@Solution,” then organizing program 126 compares the words within the content of text field 304 with existing tags to determine that the phrase “figure out” within the content is synonymous with the tag “@Solution.” Organizing program 124 then associates the content of text field 304 with the tag “@Solution.” In the example embodiment, a single input field and corresponding content may be associated with any number of tags. Furthermore, content may be tagged by users other than the creator of the content. In the example embodiment, if the user does not tag the extracted content nor does organizing program 126 determine that words within the extracted content match one or more existing tags, the content is categorized as untagged/miscellaneous.

Referring again to the flowchart illustrated by FIG. 2, organizing program 126 determines whether to display the tags corresponding to the content in lieu of the content itself (decision 208). In the example embodiment, organizing program 126 determines whether to display the tags in lieu of the content by first determining a ratio of screen area consumed by the tagged content to the available device screen area. Organizing program 126 then compares this determination, known as a viewing ratio, to a threshold value set by the user or set by program defaults. In the example embodiment, organizing program 126 determines the screen area of computing devices 110 (illustrated by screen 306 in FIG. 3) by communicating with the operating system of computing devices 110 to determine the maximum amount of coordinate values (or pixels) which can be displayed in the x and y directions of screen 306 of computing device 110. Screen area is often maintained using a coordinate system which stretches along the x and y axis of the device screen. For example, if the top left corner of screen 306 in FIG. 3 starts at (0, 0) and ends at the bottom right of screen 306 at (x, y), then the square area screen 306 is x multiplied by y. In addition to determining the size of screen 306, organizing program 124 communicates with software clients 112 to determine how collaborative file 124 is adapted to screen 306 of computing devices 110. For example, if collaborative file 124 is scaled down or redirected to a mobile site when viewed on mobile devices, organizing program 124 takes into account the scaling or manipulation of the data by communicating with software clients 112.

In the example embodiment, organizing program 124 determines how much of the screen area is utilized by the tagged content of collaborative file 124, illustrated in FIG. 3 by consumed screen 308, by analyzing the programming code associated with collaborative file 124 and identifying the size of the identified input fields 302 and 304 (decision 208 cont'd). For example, if collaborative file 124 is a webpage, calculating consumed screen 308 involves identifying the size of the containers in which the content is displayed and determining how the containers are displayed on screen 306 of computing devices 110. Organizing program 126 then adds up consumed area 308 and, when necessary, converts it to a comparable value in terms of utilized screen area. For example, if containers making up consumed screen 308 are measured in pixels and the size of screen 306 is measured in coordinates, organizing program 126 converts the pixel measurement into a comparable value in terms of coordinates or vice versa. In the example embodiment, a user may set the viewing ratio of consumed screen 308 to screen 306 at any percentage or ratio, for example greater than or equal to 200% (ratio of 2), such that if the size of consumed screen 308 doubles screen 306, the extracted content is replaced with a corresponding tag. Referencing the example illustrated by FIG. 3, if organizing program 126 determines that text fields 302 and 304 making up consumed screen 308 consume double screen 306 of computing device 110 (the user must scroll an additional page to view Comments 148 and 149), then organizing program 126 determines a viewing ratio (consumed screen 308 to screen 306) of 2 and determines that consumed screen 308 should be replaced with a corresponding tag. Conversely, if organizing program 126 determines that the ratio of consumed screen 308 to screen 306 does not exceed the configured viewing ratio, then organizing program 126 determines that consumed screen 308 should not be replaced with a corresponding tag. Continuing the example illustrated by FIG. 3, if text field 304 (Comment 148) is removed from collaborative file 124 and text field 302 (Comment 149) only consumes 50% of the viewing screen of computing device 110, then the viewing ratio does not exceed the threshold ratio of 2 and organizing program 126 does not replace text field 302.

In the example embodiment, organizing program 124 may be configured to determine a viewing ratio for each individual editable text field, sections of a document, or selected groups of editable text fields (decision 208 cont'd). For example, organizing program 126 may replace content associated with the “@Fix” tag by the corresponding “@Fix” tag when content corresponding to “@Fix” consumes 30% of the display screen size. Furthermore, in the example embodiment, organizing program 126 may be configured to always replace or leave content associated with specific tags. For example, a user may configure organizing program 126 to never replace content associated with the tag “@Fix.” In further embodiments, tags may be prioritized such that content corresponding to specified tags are replaced until the viewing ratio drops below the user-set threshold. For example, a user may configure organizing program 126 to replace content corresponding to a first priority tag, such as “@Fix,” and then check the viewing ratio again and, if the ratio is still greater than the threshold ratio, replace a next priority tag, such as “@ReproStep.” This process may be repeated until the viewing ratio falls under the user-set threshold such that content corresponding to a tag at the bottom of the priority list is the last to be replaced by a tag. In addition to increasing available screen real estate, replacing content with tags is advantageous in subsequently and rapidly categorizing, filtering, querying, and visualizing the content associated with each tag (described in greater detail below). In the example embodiment, the amount of screen real estate increased by replacing extracted content with associated tags depends on the amount of content replaced as well as the configuration/size/number of tiles replacing the content. While, in the example embodiment, tag tiles can be as small as a recognizable character/symbol and even incorporate a separate legend, other tiles may incorporate images and other media indicating a corresponding tag. Content replacement and display is described with more detail below.

In the example embodiment, organizing program 126 may display the tags in lieu of the content based on other factors as well, such as a user input (decision 208 cont'd). In the example embodiment, the user of computing devices 110 may manually select an option to group and display the content based on tags. In such embodiments, an option may be incorporated into the heading of an editable text field section, for example the “Comments” header shown in FIG. 3, as a toggle switch for ease of use.

If organizing program 126 determines not to display tags in lieu of the corresponding content (decision 208 “NO” branch), organizing program 126 continues to identify editable text fields (step 202), extract content from the identified text fields (step 204), and identify corresponding tags (step 206) until organizing program 126 determines to display the tags in lieu of the content (decision 208 “YES” branch).

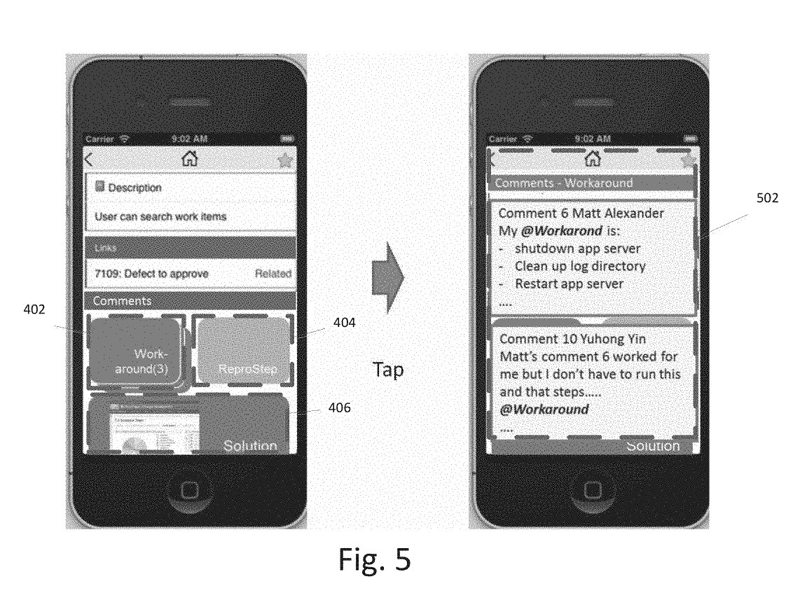

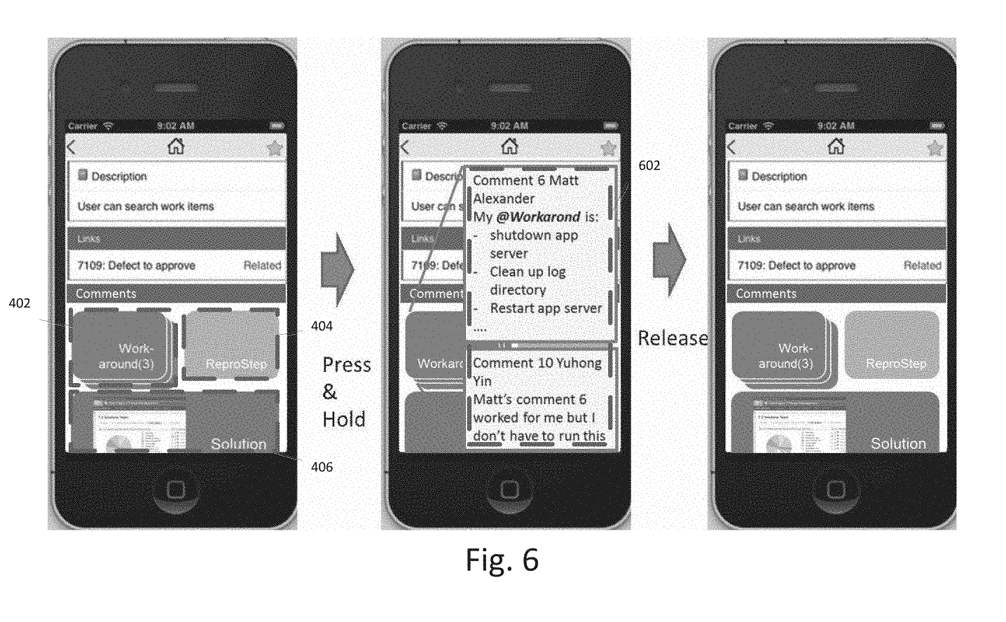

If organizing program 126 determines to display tags in lieu of the corresponding content (decision 208 “YES” branch), organizing program 126 displays the corresponding tags and monitors the tags for a user input to display the content corresponding to the selected tag (step 210). In the example embodiment, user input is entered via the user interface of software clients 112 on computing devices 110. Furthermore, the tags are displayed in lieu of the content within the original footprint of the content, as illustrated by FIG. 4, and each tag is represented by a selectable tile. In addition, each selectable tile may include an indication of how much content is associated with the tag, such as a numeric (3) as illustrated by tile 402 of FIG. 4, as well as a picture or graphical representation of the content(s) as depicted by tile 406 of FIG. 4. In the example embodiment, selecting (tapping on a touchscreen or clicking with a mouse) one of tiles 402, 404, or 406 displays the content corresponding to the tag in window 502 illustrated in FIG. 5. As illustrated by FIG. 5, if the user selects the “@Work-around” tile 402, organizing program 126 displays only the content tagged as “@Work-around” illustrated by window 502. Furthermore, in the example embodiment, if a user taps and holds one of tiles 402, 404, or 406, the contents associated with the corresponding tag are previewed in preview window 602 illustrated by FIG. 6. In the example embodiment, if the preview contents exceed screen 306 (determined in a similar manner as the viewing ratio above), organizing program 126 auto-scrolls through preview window 602 content while the user continues to hold tile 402. As illustrated by FIG. 6, if the user selects and holds “@Work-around” tile 402, the associated contents are previewed within preview window 602 and, if the contents exceed the size of screen 306, are scrolled at a user defined pace until the user releases tile 402, at which point preview window 602 is closed.

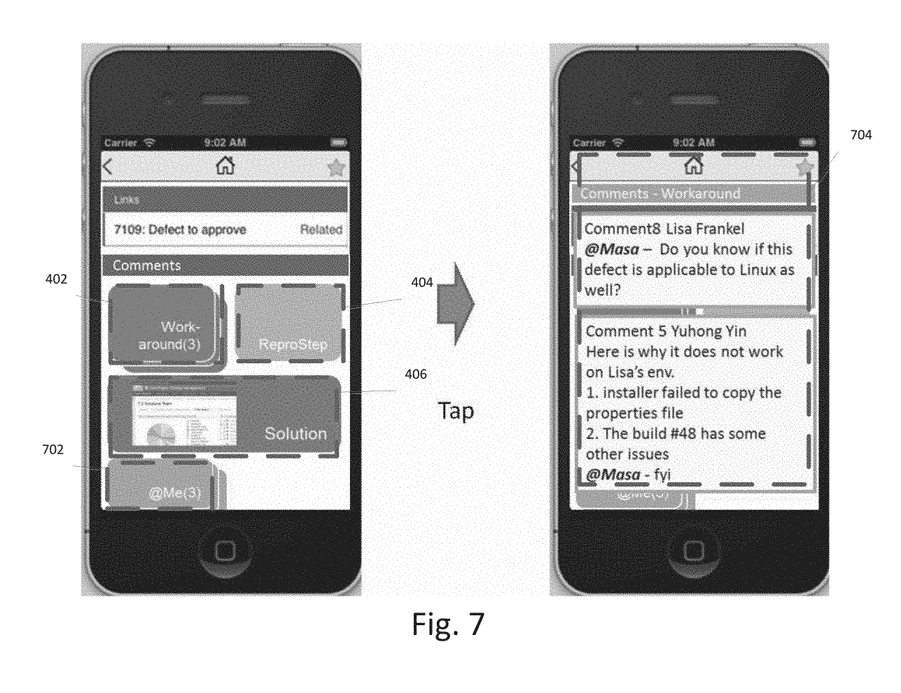

In the example embodiment, the number of displayed tiles is dependent on the number of tags associated with the content of collaborative file 124 (step 210 cont'd). In addition, tiles may be altered in color, size, or appearance based on the contents associated with a corresponding tag. For example, tiles corresponding to tags with more associated content may be larger in size. Similarly, tiles corresponding to tags that have recently been associated with new content may be colored red to indicate a hot tag or blue to indicate a cold tag (no recently associated content). However, the displayed tiles may be customized and/or prioritized. For example, refer to FIG. 7 wherein Masa Koinuma has configured organizing program 126 to always display tile 702 corresponding to content tagged with his own name, “@Me.” Selecting tile 702 opens window 704 detailing extracted content tagged with “@Me.” Similarly, organizing program 126 may be further configured to user satisfaction. For example, organizing program 126 may be configured to display tag tiles in descending order of tagged contents, display only tiles with a specified number of tagged content, display a maximum number of tiles, display specific tiles in specific circumstances, and the like.

FIG. 3 is a graphical depiction of the software client on computing device 110 of FIG. 1 prior to organization of the data by the organizing program of FIG. 1, in accordance with an embodiment of the present invention. The FIG. 3 depiction corresponds to the collaborative file of FIG. 1 prior to a Decision 208 “YES” determination in the FIG. 2 flowchart. FIG. 3 includes text field 302, text field 304, screen 306, and consumed screen 308.

FIG. 4 is a graphical depiction of the software client of FIG. 1 following organization of the data by the organizing program of FIG. 1, in accordance with an embodiment of the present invention. The FIG. 4 depiction corresponds to the collaborative file of FIG. 1 following a Decision 208 “YES” determination in the FIG. 2 flowchart. FIG. 4 includes tile 402, tile 404, and tile 406.

FIG. 5 is a graphical depiction of the software client of FIG. 1 following a user selection of a tile associated with a tag, in accordance with an embodiment of the present invention. The FIG. 5 depiction corresponds to the collaborative file of FIG. 1 following a user selection described by Step 210 in the FIG. 2 flowchart. FIG. 5 includes window 502.

FIG. 6 is a graphical depiction of the software client of FIG. 1 throughout a user press, hold, and release of a tile associated with a tag, in accordance with an embodiment of the present invention. The FIG. 6 depiction corresponds to the collaborative file of FIG. 1 following a user selection described by Step 210 in the FIG. 2 flowchart. FIG. 6 includes preview window 602.

FIG. 7 is a graphical depiction of the software client of FIG. 1 following a user selection of a tile associated with a tag, in accordance with an embodiment of the present invention. The FIG. 7 depiction corresponds to the collaborative file of FIG. 1 following a user selection described by Step 210 in the FIG. 2 flowchart. FIG. 7 includes tile 702 and window 704.

FIG. 8 is a block diagram depicting the hardware components of the data organizing system of FIG. 1, in accordance with an embodiment of the invention.

Computing device 110 may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11, for example, organizing program 126, are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 14 to read from and write to one or more portable computer readable storage media 26. Application programs 11 on computing device 110 may be stored on one or more of the portable computer readable storage media 26, read via the respective R/W drive or interface 14 and loaded into the respective computer readable storage media 08.

Computing device 110 may also include a network adapter or interface 16, such as a TCP/IP adapter card or wireless communication adapter (such as a 4G wireless communication adapter using OFDMA technology). Application programs 11 on computing device 110 may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Computing device 110 may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

Various embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

By the expression “a/one” should be understood as “at least one”.

By the expression “comprise(s)/comprising a/one” should be understood as “comprise(s)/comprising at least one”.

By the expression “comprise(s)/comprising” should be understood as “comprise(s)/comprising at least”.

By the expression “/” should be understood as “and/or”.

What is claimed is:

1. A method for a data organizing system, the method comprising:
identifying, by a computer, one or more text fields;
extracting, by the computer, content from at least one of the one or more text fields;
identifying, by the computer, one or more tags associated with the content;
storing, by the computer, the identified one or more tags in association with the content; and
determining, by the computer, whether to display the one or more tags instead of the content.

2. The method of claim 1, wherein the step of determining whether to display the one or more tags instead of the content further comprises:
determining, by the computer, a screen size associated with a screen of a device displaying the content;
determining, by the computer, a content size associated with the content when displayed on the screen of the device;
determining, by the computer, whether a viewing ratio exceeds a threshold value, wherein the viewing ratio is based on comparing the content size to the screen size; and
based on determining that the viewing ratio exceeds the threshold value, displaying, by the computer, one or more tiles corresponding to the one or more tags instead of the content associated with the one or more tags.

3. The method of claim 2, further comprising:
receiving, by the computer, a priority list corresponding to the one or more tags, wherein the priority list corresponding to the one or more tags identifies an order in which the content corresponding to the one or more tags are to be replaced by the corresponding one or more tiles.

4. The method of claim 2, further comprising:
responsive to detecting a touch to the screen of the device at a first tile of the one or more tiles, displaying, by the computer, the content associated with the one or more tags which correspond to the first tile of the one or more tiles.

5. The method of claim 2, further comprising:
responsive to detecting a tap and hold gesture at a second tile of the one or more tiles, displaying and auto scrolling, by the computer, through the content associated with the one or more tags which correspond to the second tile of the one or more tiles; and
responsive to detecting a release of the tap and hold gesture at the second tile of the one or more tiles, no longer displaying and auto scrolling, by the computer, through the content.

6. The method of claim 2, further comprising:
providing, by the computer, one or more options to sort the content based on the one or more tags.

7. The method of claim 1, wherein the step of identifying one or more tags associated with the content further comprises:
identifying one or more words within the content; and
determining whether at least one of the one or more words within the content matches at least one keyword detailed by a database of one or more keywords.

8. A computer program product for a data organizing system, the computer program product comprising:
one or more computer-readable storage media and program instructions stored on the one or more computer-readable storage media, the program instructions comprising:
program instructions to identify one or more text fields;
program instructions to extract content from at least one of the one or more text fields;
program instructions to identify one or more tags associated with the content;
program instructions to store the identified one or more tags in association with the content; and
program instructions to determine whether to display the one or more tags instead of the content.

9. The computer program product of claim 8, wherein the program instructions to determine whether to display the one or more tags instead of the content further comprises:
program instructions to determine a screen size associated with a screen of a device displaying the content;
program instructions to determine a content size associated with the content when displayed on the screen of the device;
program instructions to determine whether a viewing ratio exceeds a threshold value, wherein the viewing ratio is based on comparing the content size to the screen size; and
based on determining that the viewing ratio exceeds the threshold value, program instructions to display one or more tiles corresponding to the one or more tags instead of the content associated with the one or more tags.

10. The computer program product of claim 9, further comprising:
program instructions to receive a priority list corresponding to the one or more tags, wherein the priority list corresponding to the one or more tags identifies an order in which the content corresponding to the one or more tags are to be replaced by the corresponding one or more tiles.

11. The computer program product of claim 9, further comprising:
responsive to detecting a touch to the screen of the device at a first tile of the one or more tiles, program instructions to display the content associated with the one or more tags which correspond to the first tile of the one or more tiles.

12. The computer program product of claim 9, further comprising:
responsive to detecting a tap and hold gesture at a second tile of the one or more tiles, program instructions to display and auto scroll through the content associated with the one or more tags which correspond to the second tile of the one or more tiles; and
responsive to detecting a release of the tap and hold gesture at the second tile of the one or more tiles, program instructions to no longer display and auto scroll through the content.

13. The computer program product of claim 9, further comprising:
program instructions to provide one or more options to sort the content based on the one or more tags.

14. The computer program product of claim 8, wherein the program instructions to identify one or more tags associated with the content further comprises:
program instructions to identify one or more words within the content; and
program instructions to determine whether at least one of the one or more words within the content matches at least one keyword detailed by a database of one or more keywords.

15. A computer system for a data organizing system, the computer system comprising:
one or more computer processors, one or more computer-readable storage media, and program instructions stored on one or more of the computer-readable storage media for execution by at least one of the one or more processors, the program instructions comprising:
program instructions to identify one or more text fields;
program instructions to extract content from at least one of the one or more text fields;
program instructions to identify one or more tags associated with the content;
program instructions to store the identified one or more tags in association with the content; and
program instructions to determine whether to display the one or more tags instead of the content.

16. The computer system of claim 15, wherein the program instructions to determine whether to display the one or more tags instead of the content further comprises:
program instructions to determine a screen size associated with a screen of a device displaying the content;
program instructions to determine a content size associated with the content when displayed on the screen of the device;
program instructions to determine whether a viewing ratio exceeds a threshold value, wherein the viewing ratio is based on comparing the content size to the screen size; and
based on determining that the viewing ratio exceeds the threshold value, program instructions to display one or more tiles corresponding to the one or more tags instead of the content associated with the one or more tags.

17. The computer system of claim 16, further comprising:
program instructions to receive a priority list corresponding to the one or more tags, wherein the priority list corresponding to the one or more tags identifies an order in which the content corresponding to the one or more tags are to be replaced by the corresponding one or more tiles.

18. The computer system of claim 16, further comprising:
responsive to detecting a touch to the screen of the device at a first tile of the one or more tiles, program instructions to display the content associated with the one or more tags which correspond to the first tile of the one or more tiles.

19. The computer system of claim 16, further comprising:
responsive to detecting a tap and hold gesture at a second tile of the one or more tiles, program instructions to display and auto scroll through the content associated with the one or more tags which correspond to the second tile of the one or more tiles; and
responsive to detecting a release of the tap and hold gesture at the second tile of the one or more tiles, program instructions to no longer display and auto scroll through the content.

20. The computer program product of claim 16, further comprising:
program instructions to provide one or more options to sort the content based on the one or more tags.
